(19) United States
(12) Patent Application Publication
(10) Pub. No.: US 2020/0344394 A1
(43) Pub. Date: Oct. 29, 2020

(54) CAMERA MODULE

(71) Applicant: PRIMAX ELECTRONICS LTD., Taipei City (TW)

(72) Inventor: YI-CHING TSAI, Taipei City (TW)

(21) Appl. No.: 16/517,726

(22) Filed: Jul. 22, 2019

(30) Foreign Application Priority Data
Apr. 26, 2019 (TW) 108114764

(51) Int. Cl. H04N 5/225; G02B 7/02; G02B 7/00

(52) U.S. Cl. CPC H04N 5/2257; G02B 7/021; G02B 13/001; H04N 5/2254; G02B 7/006

(57) ABSTRACT

A camera module includes a casing, a lens assembly, a sensing chip assembly and a filter element. The casing has an opening. The lens assembly is disposed within the casing. The sensing chip assembly is connected with the lens assembly. The filter element is located near the opening and arranged in front of the lens assembly. The filter element is used for filtering ambient light beams. The first-wavelength beams of the ambient light beams are transmissible through the filter element. The second-wavelength beams of the ambient light beams are filtered off by the filter element. Due to the arrangement of the filter element, the second-wavelength beams are not projected to the driver's eyes.

### FIELD OF THE INVENTION

The present invention relates to a camera module, and more particularly to a camera module for increasing driving safety.

### BACKGROUND OF THE INVENTION

Recently, mobile communication devices, personal digital assistants (PDA) or other portable electronic devices with camera modules are widely used. The camera modules can be used to shoot the scene whenever and wherever the users are. Consequently, commemorative images or movies are generated. Generally, a camera module comprises a lens assembly and a sensing chip. After ambient light beams pass through the lens assembly, the ambient light beams are refracted. The sensing chip has a sensing area. When the ambient light beams passing through the lens assembly are imaged on the sensing area, an image is generated.

Since the camera module has good recording capability, the camera module can be applied to various electronic products. For example, the camera module in the driving safety field (e.g., the so-called dashboard camera) is one of the widely-used camera modules. With the increasing development of science and technology, the functions of the camera module in the driving safety field are gradually increased. Recently, a camera module in the driving safety field is introduced into the market to record the driving images and record the facial expression of the driver. This camera module has the function of detecting whether the driver's eyes are closed. If the camera module detects that the user's eye is closed, the camera module issues a warning message. In other words, the camera module is capable of detecting the metal condition of the user during the driving process.

As mentioned above, when the ambient light beams passing through the lens assembly are imaged on the sensing area, an image is generated. For normally operating the camera module, the luminous intensity of the ambient light beams needs to be sufficient. As known, the vehicles or motorcycles may be driven in day or night. When the vehicle or the motorcycle is driven in the dark environment (e.g., in the night), the luminous intensity of the ambient light beams is low. Under this circumstance, the quality of the image generated by the camera module with the driving safety capability is not satisfied. For solving this drawback, the camera module with the driving safety capability is additionally equipped with an internal light source to increase the luminous intensity within the camera module. The additional light source can overcome the problems caused by the insufficient luminous intensity of the ambient light beams. However, the light beams generated by the internal light source are possibly leaked out of the camera module. If the light beams are projected to the driver's eyes, the driver's eyesight is blocked and a car accident possibly occurs.

Therefore, there is a need of providing a camera module with increased safety capability.

### SUMMARY OF THE INVENTION

An object of the present invention provides a camera module with increased safety capability.

In accordance with an aspect of the present invention, a camera module is provided. The camera module includes a casing, a lens assembly, a sensing chip assembly and a filter element. The casing has an opening. The lens assembly is disposed within the casing and inserted into the opening. The sensing chip assembly is disposed within the casing and connected with the lens assembly. The filter element is located near the opening and arranged in front of the lens assembly for sheltering the lens assembly and filtering ambient light beams. The first-wavelength beams of the ambient light beams are transmissible through the filter element. The second-wavelength beams of the ambient light beams are filtered off by the filter element. The second-wavelength beams are not reflected by the filter element. The first-wavelength beams are invisible light beams. The second-wavelength beams are visible light beams.

In an embodiment, the camera module further includes a light source assembly. The light source assembly is disposed within the casing and located near the opening. The light source assembly emits illumination light beams. The light source assembly includes a first circuit board and a light-emitting element. The first circuit board is disposed within the casing and located near the opening. The light-emitting element is installed on the first circuit board and inserted into the opening. The light-emitting element emits the illumination light beams. The first circuit board has a perforation. The lens assembly is penetrated through the perforation and inserted into the opening.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a camera module according to an embodiment of the present invention;

FIG. 2 is a schematic exploded view illustrating a portion of the camera module according to the embodiment of the present invention;

FIG. 3 is a schematic functional block diagram illustrating the filter element and the control mechanism of the camera module according to the embodiment of the present invention;

FIG. 4 is a schematic top view illustrating the filter element of the camera module according to the embodiment of the present invention; and

FIG. 5 is a schematic perspective view the camera module according to the embodiment of the present invention, in which the filter element is moved to a second position.

### DETAILED DESCRIPTION OF THE PREFERRED EMBODIMENT

For solving the drawbacks of the conventional technology, the present invention provides a camera module. The embodiments of present invention will be described more specifically with reference to the following drawings. For well understanding the present invention, the elements shown in the drawings are not in scale with the elements of the practical product. In the following embodiments and drawings, the elements irrelevant to the concepts of the present invention or the elements well known to those skilled in the art are omitted. It is noted that numerous modifications and alterations may be made while retaining the teachings of the invention.

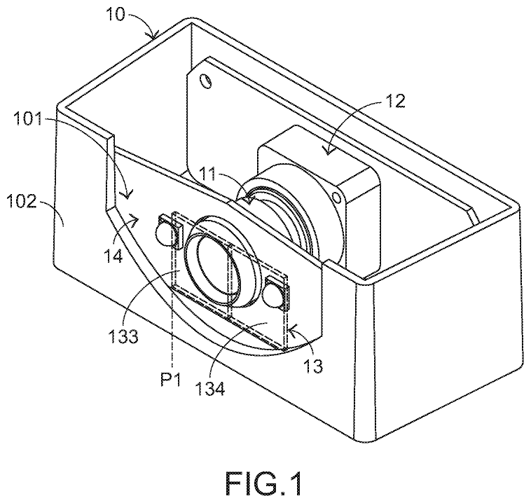

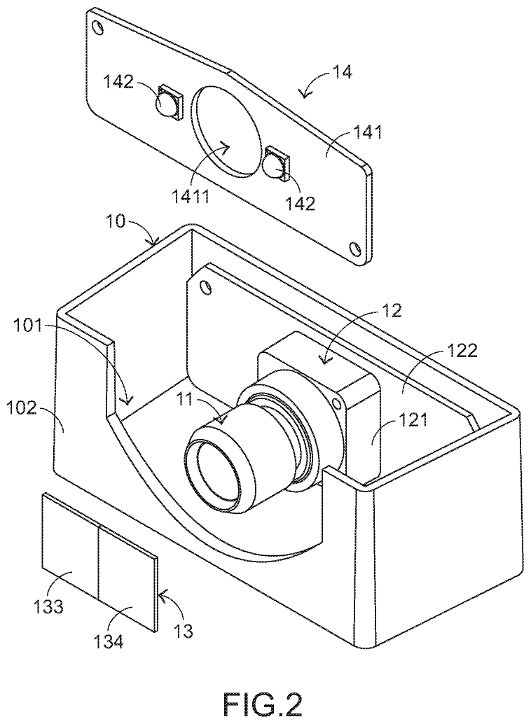

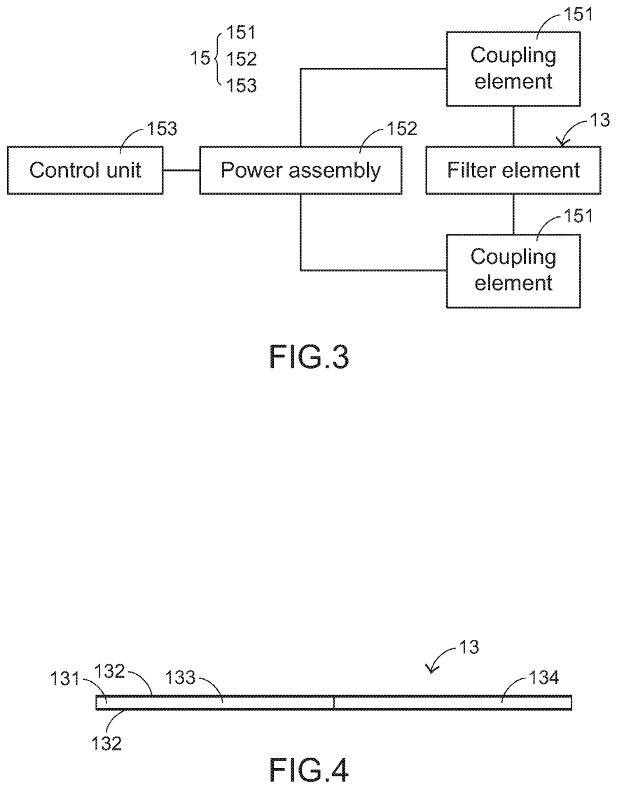

The structure of the camera module will be described as follows. Please refer to FIGS. 1 and 2. FIG. 1 is a schematic perspective view illustrating a camera module according to an embodiment of the present invention. FIG. 2 is a schematic exploded view illustrating a portion of the camera module according to the embodiment of the present invention. The camera module 1 comprises a casing 10, a lens assembly 11, a sensing chip assembly 12, a filter element 13, a light source assembly 14 and a control mechanism 15 (see FIG. 3). The casing 10 has an opening 101. The opening 101 is formed in a middle region of a lateral side 102 of the casing 10. The lens assembly 11 is disposed within the casing 10 and located near the opening 101. The ambient light beams can pass through the lens assembly 11. The lens assembly 11 comprises plural lenses. According to the characteristics of the plural lenses, the optical paths of the ambient light beams are changeable. The sensing chip assembly 12 is disposed within the casing 10 and connected with the lens assembly 11.

The filter element 13 is located near the opening 101 and arranged in front of the lens assembly 11. The filter element 13 has the following two functions. Firstly, the filter element 13 can shelter the lens assembly 11. Consequently, the lens assembly 11 is not exposed outside the camera module 1. Secondly, the filter element 13 can filter the ambient light beams. Consequently, the first-wavelength beams in the ambient light beams are transmissible through the filter element 13, and the second-wavelength beams in the ambient light beams are filtered off by the filter element 13. In an embodiment, the filter element 13 is made of a light-transmissible material, the first-wavelength beams are invisible light beams, and the second-wavelength beams are visible light beams. Moreover, the second-wavelength beams cannot be reflected by the filter element 13. Since the second-wavelength beams are not reflected by the filter element 13, the second-wavelength beams will not be projected to the driver's eyes.

Please refer to FIGS. 1 and 2 again. The light source assembly 14 is disposed within the casing 10 and located near the opening 101. The light source assembly 14 emits light beams. In an embodiment, the light source assembly 14 comprises a first circuit board 141 and plural light-emitting elements 142. The first circuit board 141 is disposed within the casing 10 and located near the opening 101. The first circuit board 141 has a perforation 1411. The lens assembly 11 is penetrated through the perforation 1411 of the first circuit board 141 and inserted into the opening 101. The plural light-emitting elements 142 are installed on the first circuit board 141 and inserted into the opening 101. The plural light-emitting elements 142 emit plural illumination light beams. The second-wavelength beams of the illumination light beams are also filtered off by the filter element 13. In an embodiment, the first circuit board 141 is a printed circuit board (PCB).

The sensing chip assembly 12 comprises a sensing chip 121 and a second circuit board 122. The sensing chip 121 is connected with the lens assembly 11. After the ambient light beams passing through the lens assembly 11 are received by the sensing chip 121, an image is generated. The second circuit board 122 is connected with the sensing chip 121 for providing electricity to the sensing chip 121. In an embodiment, the sensing chip 121 is a complementary metal-oxide-semiconductor (CMOS) device, and the second circuit board 122 is a rigid-flex board, a FR4 substrate or a ceramic substrate.

FIG. 3 is a schematic functional block diagram illustrating the filter element and the control mechanism of the camera module according to the embodiment of the present invention. The control mechanism 15 is connected with the filter element 13. The control mechanism 15 comprises plural coupling elements 151, a power assembly 152 and a control unit 153. The plural coupling elements 151 are connected with a lateral side of the filter element 13. The power assembly 152 is connected with the plural coupling elements 151. The power assembly 152 provides motive power to the plural coupling elements 151. Consequently, the plural coupling elements 151 are enabled to move the filter element 13 relative to the casing 10. The control unit 153 is connected with the power assembly 152 to control the operations of the power assembly 152. In an embodiment, the control unit 153 is a microprocessor, and the power assembly 152 is a motor, a traction mechanism or any other appropriate power device.

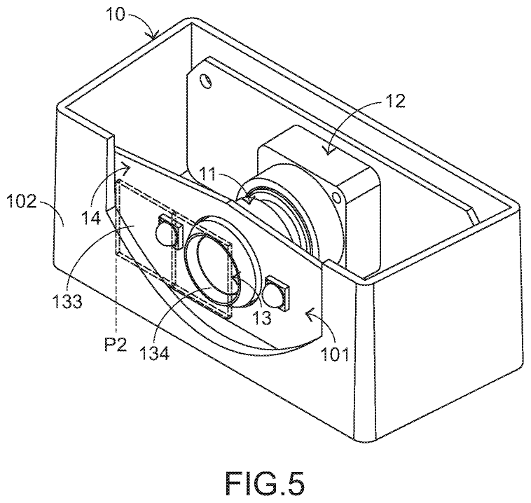

FIG. 4 is a schematic top view illustrating the filter element of the camera module according to the embodiment of the present invention. Please refer to FIGS. 1, 2 and 4. The filter element 13 comprises a plate body 131 and a coating layer 132. The plate body 131 is located near the opening 101 and arranged in front of the lens assembly 11. The coating layer 132 is formed on an outer surface of the plate body 131. The first-wavelength beams are transmissible through the plate body 131 and the coating layer 132. The second-wavelength beams are filtered off by the coating layer 132, and thus the second-wavelength beams are blocked by the coating layer 132. Preferably but not exclusively, the coating layer 132 of the filter element 13 is formed by using a coating process. It is noted that numerous modifications and alterations may be made while retaining the teachings of the invention. In another embodiment, the filter element is a colored glass plate or a dyed film. The composition of the colored glass plate or the dyed film is determined according to the structure of the lens assembly.

In an embodiment, the filter element 13 is specially designed. As shown in FIGS. 2 and 4, the filter element 13 comprises a first filtering region 133 and a second filtering region 134. The first filtering region 133 is located at a first side of the filter element 13. The third-wavelength beams of the first-wavelength beams are transmissible through the first filtering region 133. The second-wavelength beams are filtered off by the first filtering region 133. The second filtering region 134 is located at a second side of the filter element 13. The fourth-wavelength beams of the first-wavelength beams are transmissible through the second filtering region 134. The second-wavelength beams are filtered off by the second filtering region 134. Since the filter element 13 is specially designed, the light beams with the specified wavelength can be transmitted through the filter element 13. In an embodiment, the wavelength of the third-wavelength beams is in the range between 830 nm and 860 nm, and the wavelength of the fourth-wavelength beams is in the range between 930 nm and 960 nm.

The operations of the camera module 1 will be described as follows. FIG. 5 is a schematic perspective view the camera module according to the embodiment of the present invention, in which the filter element is moved to a second position. Please refer to FIGS. 1, 3 and 5. For allowing the third-wavelength beams to pass through the filter element 13 according to the settings, the control unit 153 drives the power assembly 152. Consequently, the plural coupling elements 151 are enabled to move the filter element 13 relative to the casing 10. As shown in FIG. 1, the filter element 13 is moved to a first position P1. Meanwhile, the first filtering region 133 is moved to the region in front of the lens assembly 11. For allowing the fourth-wavelength beams to pass through the filter element 13 according to the settings, the control unit 153 drives the power assembly 152. Consequently, the plural coupling elements 151 are enabled to move the filter element 13 relative to the casing 10. As shown in FIG. 5, the filter element 13 is moved to a second position P2. Meanwhile, the second filtering region 134 is moved to the region in front of the lens assembly 11.

From the above descriptions, the present invention provides the camera module. The filter element is arranged in front of the opening of the casing. The lens assembly is sheltered by the filter element. Consequently, the appearance is aesthetically-pleasing. Moreover, the ambient light beams and the illumination light beams from the light source assembly are filtered by the filter element. Especially, the visible light beams are not reflected by the filter element, and greater portions of the visible light beams are filtered off by the filter element. Consequently, the visible light beams are not projected to the driver's eyes. In other words, the camera module of the present invention is effective to overcome the drawbacks of the conventional technologies.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A camera module, comprising:
a casing having an opening;
a lens assembly disposed within the casing and inserted into the opening;
a sensing chip assembly disposed within the casing and connected with the lens assembly; and
a filter element located near the opening and arranged in front of the lens assembly for sheltering the lens assembly and filtering ambient light beams, wherein first-wavelength beams of the ambient light beams are transmissible through the filter element, and second-wavelength beams of the ambient light beams are filtered off by the filter element, wherein the second-wavelength beams are not reflected by the filter element.

2. The camera module according to claim 1, wherein the camera module further comprises a light source assembly, wherein the light source assembly is disposed within the casing and located near the opening, and the light source assembly emits illumination light beams, wherein second-wavelength beams of the illumination light beams are filtered off by the filter element.

3. The camera module according to claim 2, wherein the light source assembly comprises:
a first circuit board disposed within the casing and located near the opening; and
a light-emitting element installed on the first circuit board and inserted into the opening, wherein the light-emitting element emits the illumination light beams, the first circuit board has a perforation, and the lens assembly is penetrated through the perforation and inserted into the opening.

4. The camera module according to claim 1, wherein the first-wavelength beams are invisible light beams, and the second-wavelength beams are visible light beams.

5. The camera module according to claim 1, wherein the sensing chip assembly comprises:
a sensing chip connected with the lens assembly, wherein after the ambient light beams passing through the lens assembly are received by the sensing chip, an image is generated; and
a second circuit board connected with the sensing chip.

6. The camera module according to claim 1, wherein the filter element comprises:
a plate body located near the opening and arranged in front of the lens assembly; and
a coating layer formed on an outer surface of the plate body, wherein the first-wavelength beams are transmissible through the plate body and the coating layer, wherein the second-wavelength beams are filtered off by the coating layer, so that the second-wavelength beams are blocked by the coating layer.

7. The camera module according to claim 1, wherein the filter element is a colored glass plate or a dyed film.

8. The camera module according to claim 1, wherein the filter element comprises:
a first filtering region located at a first side of the filter element, wherein third-wavelength beams of the first-wavelength beams are transmissible through the first filtering region, and the second-wavelength beams are filtered off by the first filtering region; and
a second filtering region located at a second side of the filter element, wherein fourth-wavelength beams of the first-wavelength beams are transmissible through the second filtering region, and the second-wavelength beams are filtered off by the second filtering region.

9. The camera module according to claim 8, wherein the camera module further comprises a control mechanism, wherein the control mechanism is connected with the filter element, and the control mechanism comprises:
a coupling element connected with the filter element;
a power assembly connected with the coupling element, wherein the power assembly provides motive power to the coupling element, so that the coupling element is enabled to move the filter element relative to the casing; and
a control unit connected with the power assembly to control operations of the power assembly, wherein when the filter element is moved to a first position, the first filtering region is moved to a position in front of the lens assembly, wherein when the filter element is moved to a second position, the second filtering region is moved to a position in front of the lens assembly.
